(19) United States
(12) Patent Application Publication
(10) Pub. No.: US 2004/0158534 A1
(43) Pub. Date: Aug. 12, 2004

(54) System facilitating a purchase transaction over a wireless network

(76) Inventors: Bahram Seyed Zahir Azami, Ottawa (CA); Mohammad M. Tanabian, Kanata (CA)

Correspondence Address: BLAKE, CASSELS & GRAYDON, LLP, 45 O'CONNOR ST., 20TH FLOOR, OTTAWA, ON, K1P 1A4, CA

(21) Appl. No.: 10/778,028

(22) Filed: Feb. 17, 2004

Related U.S. Application Data
(60) Provisional application No. 60/449,452, filed on Feb. 24, 2003.

(51) Int. Cl. G06F 17/60

(52) U.S. Cl. 705/75

(57) ABSTRACT

Discloses a system for a consumer to make an electronic payment at a vendor site VS 110, such as a vending machine, parking meter, and the like using the consumer's mobile user equipment UE 150, i.e., mobile phone or connected PDA. The vendor site can be attended or unattended but does not require direct connectivity of the VS 110 to a service center SC 170 to make the payment. Payment is made based on a unique code provided to the consumer at the vendor site, referred to as a transaction identification code (TID). The transaction identification code is supplied to the service center, which responds with a unique authorizing confirmation code by exchange of messages over the communications network of the user equipment UE 150. Security and data integrity is provided by means of message encryption and CRC methods. Message encryption provides transaction security over the wireless network. Suitable encryption is based on the order synchronized code, an initialization vector and key distribution system or other encryption mechanism to maintain security and integrity of the transaction. An option to support operation of the system in multiple languages is provided. The user or consumer billing and vendor payment steps necessary to complete the financial settlement of the purchase transaction is supported by a billing proxy, which can effect settlement by the user's wireless carrier or through an independent billing service provider.

### FIELD OF THE INVENTION

This invention relates to purchase transaction payment systems and more particularly relates to a payment system operable over a wireless network for use in making a purchase at an attended or an unattended vendor station or site.

### BACKGROUND OF THE INVENTION

There have been several instances of different designs and implementation of systems that enable users to pay for their purchase using their wireless or mobile device. The following is some of the cases that we have studied:

Japan: NTT DoCoMo and Coca Cola

Australia: Telstra Corp Ltd and Coca Cola

United states—PocketChange from USA Technologies

Singapore—SingTel

All of the solutions provided by the cases mentioned above require the vendor station to be connected to a data communication or a telecommunication network by some means of connectivity such as a phone line or Internet. This adds to the cost of providing the vendor station, which eliminates the use of automated payment systems in certain applications for economic reasons, for example in small amount transactions where the revenues are not sufficient to support the added cost of network connectivity for the vendor station.

### SUMMARY OF THE INVENTION

The invention described in this disclosure provides a system that enables users to pay for their purchase using their wireless or mobile device. In accordance with the system of the invention, the purchaser user's mobile device is used to convey information relating to the purchase transaction at the vendor site to a service center which completes the payment transaction and provides information to the purchaser to complete the sale. In this disclosure, the transaction discussed most frequently is a transaction involving a small sum of money. For convenience, this type of transaction will be referred to herein as a “Small Amount Transaction by Mobile” or SATM.

The SATM system is used to facilitate paying a small amount transaction using mobile user equipment or mobile device. The meaning of “small amount” depends on the context of the transaction and may vary from application to application or from time to time. The mobile device in its simplest form is a voice only cell phone or it can be a state-of-the-art mobile communication device such as cell phones or PDAs with programmable computing capabilities and data transmission capability.

The goal for this system is to ensure that any user with any type of available mobile device, at any enabled un-attended or attended vending station is able to pay for the desired vendor's goods or services with a financial transaction that has an amount up to a certain limit. With the system of the present invention, the vendor station is not required to have network connectivity through any means of data communication or telecommunication service. The carrier that the user subscribes to must have access to the SATM service. In the preferred implementation, the carrier authorizes the SATM service to enable the user to use the service by the carrier. In this implementation, the mobile user subscribes to the SATM service offering of the carrier, very much like the subscriber would subscribe to other service offerings of the carrier, such as for example, call forwarding or caller Id features.

The system of the invention would advantageously be used for transactions with vending machines, video rentals, coffee machines, fast food, cinema, sport facilities, laundries, copy machines, fax machines, Internet nodes, automatic photo taking machines, gas stations, carwashes, toll highways, bus, tramway and metro ticket sellers, taxi payments, game consuls, public washrooms, change machines, relaxation, massage and oxygen machines, donations, and any other place with enough similarity to these applications.

The invention will now be described with reference to the appended drawings.

### BRIEF DESCRIPTION OF THE DRAWINGS

FIG. 1) Is a block diagram illustrating the preferred network layers of a data exchange methodology in accordance with the principles of the invention.

FIG. 2) Is a record layout of fields present in the transaction id TID and confirmation id CID messages of FIG. 1.

FIG. 3) Depicts the process steps of a success path use case for a SATM transaction.

FIG. 4) Depicts the process steps of a failure path use case for a SATM transaction.

FIG. 5) Field layout diagram of a preferred order synchronized code.

FIG. 6) Block diagram of the encryption scheme.

FIG. 7) Block diagram of the security and error protection between SC 170 and VS 110.

FIG. 8) Snapshot of the display for choosing the product.

FIG. 9) Snapshot of the display for Displaying TID 125 and guiding the user.

FIG. 10) Snapshot of the display for Accepting CID 126 from the user.

FIG. 11) Snapshot of the display for Product release.

FIG. 12) Is a block diagram of the billing system interaction with the SC 170.

### DETAILED DESCRIPTION OF THE PREFERRED EMBODIMENT

The system of the invention permits a SATM transaction to be completed or fulfilled without the need for an explicit permanent network connection or network connectivity at a vendor site. The network connectivity and data exchange required to complete a SATM transaction is provided by the mobile communications device of the purchaser. The invention provides two different scenarios to effect a SATM transaction, namely, a user assisted data exchange (UADE) scenario and automatic data exchange (ADE) scenario. These scenarios will be described in more detail with reference to the drawings.

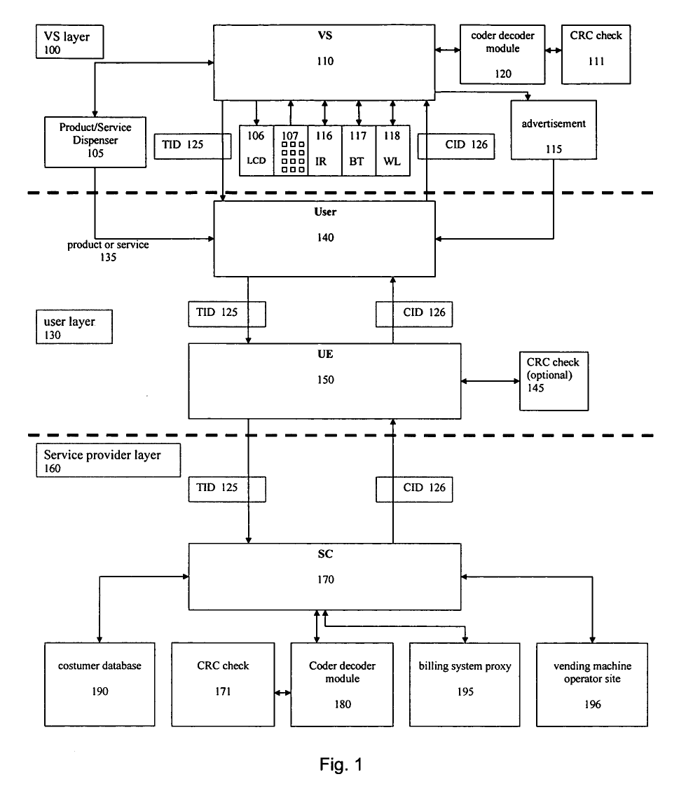

FIG. 1 is a block diagram illustrating the preferred network layers of a data exchange methodology to facilitate both UADE and ADE SATM data exchange scenarios. In a user assisted data exchange UADE SATM scenario, a user 140 reads and obtains information about the desired product or service 135 from the vendor station computer VS 110. The selected product or service at the VS 110 is identified by a unique transaction identification code TID 125, which the user enters into (i.e., punches it into) his or her mobile device UE 150. The UE 150 transmits the information over the network to which the user is a subscriber to deliver it to a service center SC 170.

The SC 170 processes the received information by interacting with a customer database 190 and a billing system proxy 195 to produce and respond with an output code, which is shown in the figure as the confirmation identification code CID 126. The CID 126 is delivered to the user mobile device UE 150. Where the display of UE 150 permits and the wireless network system is configured to so operate, the CID 126 is supplied to the user on the display of the US 150. Otherwise, the CID 126 is provided to the user audibly as an audio message produced by an attendant at the service center or produced by voice response equipment. On receiving this information, the user inputs or supplies the received CID 126 to the vendor site VS 110. In this scenario there is no need to modify the UE 150 to install new software to support the SATM service. A user can operate any regular cell phone with only simple audio or voice communications to fulfill a transaction with a SATM enabled vendor site VS 110.

In an Automatic Data Exchange (ADE) SATM scenario, the UE 150 is enabled with a means of local wireless connectivity such as Bluetooth (trademark) BT 117, Wireless LAN (802.11 and so on) 118 or Infrared 116 (IrDA for example) that is operative to communicate with the vendor site VS 110. The data exchange between the UE 150 and VS 110 is conveyed through this local connectivity. On receiving the data from the VS 110, the data needed for communication with the service center SC 170 to fulfill the transaction is provided by the VS 110. In the ADE scenario, the user plays a supervisory role only to initiate and then confirm or decline the transaction when needed. The messages are sent through SMS or other means of data communications available on the UE 150. The Infrared device on the vending machine side 110 takes control of the user equipment UE 150.

Where the vendor site is a vending machine, the SC 170 preferably also provides the inventory information for product dispenser 105 to the vending operator site 196, which would be used for inventory management and route optimization of the trucks that are used for replenishment of the vending machines.

Messaging

The main messages that are exchanged between VS 110 and the SC 170 to fulfill a SATM transaction are:

Transaction Id (TID 125) from VS 110 to SC 170

Confirmation Id (CID 126) from SC 170 to VS 110

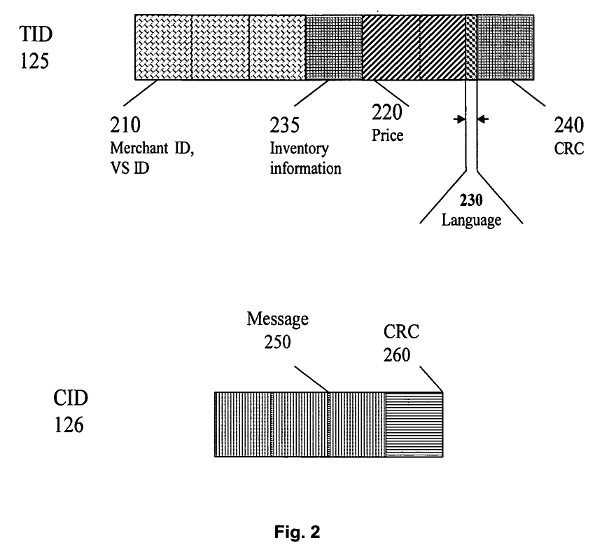

FIG. 2 shows a message layout detailing fields from each of these messages. The content of a TID 125 message preferably includes the following fields:

1. Merchant Id and Vendor Station Id 210

2. Price 220

3. Language 230

4. Error Correction (e.g., CRC) 240

The elements of CID 126 (Confirmation ID) message are preferably as follows:

1. Message (encrypted) 250

2. Error Correction (e.g., CRC) 260

With a user assisted data exchange UADE scenario SATM transaction, the user provides the input data. Therefore, it is convenient to limit the amount of information that the user must input into the mobile device UE 150, to request a transaction and, in turn, provide to the vendor site VS 110 to complete the purchase transaction. Preferably, for user convenience in the UADE scenario, the information input by the user in a TID 125 message is limited to 7 digits and the Message 250 information provided to the user in a CID 126 message is limited to 4 digits.

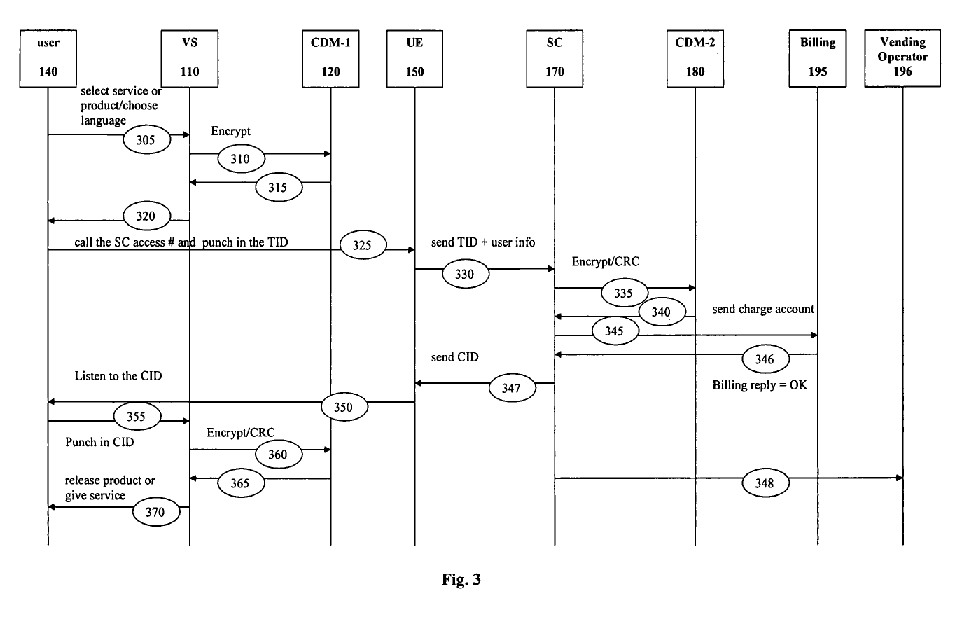

FIG. 3 depicts the process steps of a success path use case for a SATM transaction. Following remarks are in order for FIG. 3:

This is a simplified use case for the success path, and for the UADE mode. Some changes would be necessary for the ADE mode, for example, the UE 150 itself can check for the CRC.

The message 305 from user 140 to VS 110 is actually selecting the product or the desired service, for instance by pushing a (or a few) button(s)

The message 310 from the VS 110 to CMD-1 120 is a message that requires encryption. The message 315 is the encrypted version. We take note that not all parts of the message actually need to be encrypted, and using a mask only the parts of the message that require encryption are encrypted.

The message 320 is sent back to the user 140 and is actually showing the TID 125. In the Automatic mode (ADE) this TID may be transparent to the user.

The message 325 is sent from the user 140 to the UE and in UADE mode it can be that the user 140 enters the TID 125 on the UE 150.

The message 330 is sent from the UE 150 to SC 170, using the wireless connection.

The message 335 from SC 170 to CDM-2 180 is the encrypted packet that is sent for deciphering and the message 340 is the deciphered version.

The message 345 from SC 170 to Billing 195 is for actually asking for the transaction permit.

The message 346 from Billing 195 to SC 170 is the answer to the message 345 and if it says “O.K.” then it means that the transaction is approved. In the billing system the transaction waits for a predetermined time (about 10 minutes, for instance) before the user account is charged. This gives the user opportunity to cancel the requested service, in case of error or in the case user changes his/her mind.

The message 347 from SC 170 to UE 150 is CID 126.

The message 348 from SC 170 to the vending operator system 196 carries the inventory information which is extracted from TID 125. The message 350 from the UE 150 to the user 140 is also the CID 126 which in the UADE mode can be read to the user by reproducing recorded voice, using an Interactive Voice Response (IVR) system. Another solution is that this message can be sent by SMS.

The message 350 from the UE 150 to the user 140 is also the CID 126 which in the UADE mode can be read to the using IVR. Another solution is that this message can be sent by SMS and displayed on the screen of the UE 150. In case of voice, the message would read the CID 126 digit by digit and then after a short silence (of about 10 seconds) it repeats itself several times. In ADE the CID 126 will automatically be transmitted from SC 170 to VS 110 without much user interaction or even knowledge (in IR 116 mode, the user 140 may be asked to keep the UE 150 in a reasonable distance and direction to the VS 110).

The message 360 is a request for checking if the CID 126 is the correct one.

The message 365 actually says if the CID 126 is the right one that the CDM-1 120 is expecting for this particular transaction.

The message 370 from the VS 110 to the user is when everything is O.K. and simultaneously the product is released or the service is rendered.

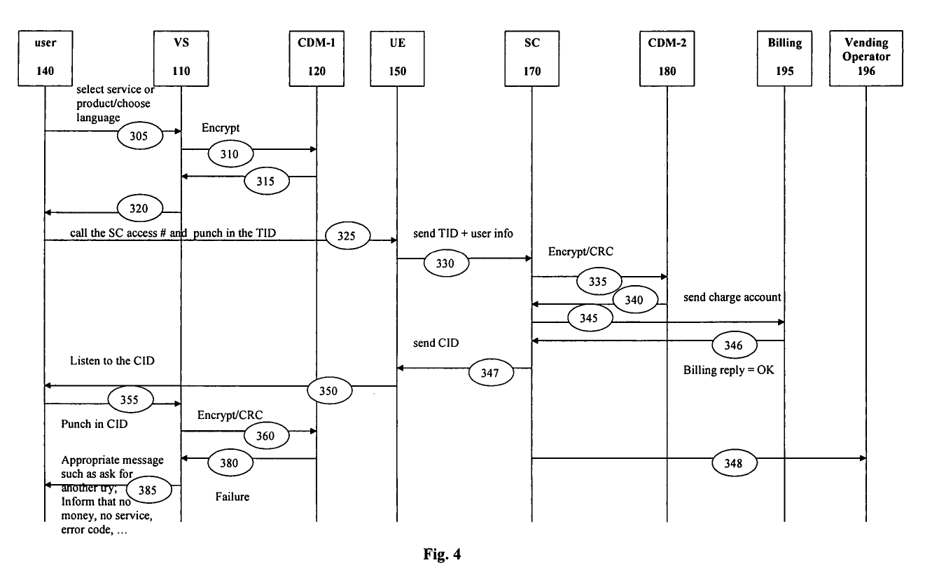

FIG. 4 is a process flow diagram depicting a simplified failure path use case to process a SATM transaction in accordance with the invention. There may be several different reasons for a SATM transaction to fail. Below are set out some of the main failure cases:

The messages in FIG. 4 are the same as in FIG. 3 except for the messages 380 and 385. Message 380 from CDM-1 120 to the VS 110 which returns an error code, which means that the CID 126 is not correct. Message 385 from the VS 110 to the user 140 reflects this error and eventually invites the user 140 to retry.

1. If SC 170 finds that CRC is not correct (this can be either because of a punching error of TID 125 by the user or any simple communication error), the user is asked to re-enter the TID 125. This happens for example for the UADE mode, when the user makes a mistake entering the TID 125 number. In that case the automatic system plays a recorded message asking the user 140 to retry.

2. One reason for a failure can be “out of sync.” If the encryption in the VS 110 is not in sync with the one in SC 170, then this failure is detected. In such a case, the VS 110 would become obsolete. Emergency message should be sent to the responsible department to make them in sync again. A message might be sent to the SC 170 to temporarily put the VS 110 out of use. The system will still accept coins, but the mobile mode will be out of order till it is given the required service.

3. If the billing system can not identify the user, or that the user does not have enough cash/credit to perform the transaction, a failure should be generated that would be understood by the VS 110 and appropriate message would be screened.

4. If the VS 110 detects that the message is not right (either the CRC is not correct, or the message is not among the allowed messages), the user would be asked to repeat the process of entering TID 125 and CID 126. If this problem occurs more than a predetermined number of times, the transaction should be cancelled by giving a special canceling TID 125 to the user; when the user enters this code, the transaction would be cancelled and the user will not be billed for this transaction.

5. If the VS 110 receives the CID 126 but at this time learns that for some reason, it can not provide the service or release the product, the same cancellation TID 125 mechanism will be applied. Of course, to guarantee a good user experience, the probability of such an event should be kept minimal.

Language Selection

Accommodating several languages in the SATM system allows it to be widely used. For example, language options allow the SATM system to be more appealing for places where more than one language are spoken, like many regions in Europe, Canada, and countries with a high immigration rate and also places with a large number of visitors who may speak different languages. A simple example in Canada is the two official languages: English and French.

To accommodate this requirement, all we need is a human interface (keys, for example) to choose the language. The TID message includes a language field 230 to accommodate multiple languages. Language support can be provided as a preset or provisioned parameter inside the cell phone (or the PDA) which is set by the user 140 once at subscription time and is always used as his/her language preference, till he/she proceeds to change it.

To accommodate two languages, we only need b=1 bit and this is what we can do for several situations, including the Canadian context, where two official languages exist. In general, to accommodate L languages, we need b=ceil(log₂(L)) bits, where ceil(.) denotes the ceiling function and log₂ is the logarithm in base 2. As an example, with just three bits, we can accommodate up to eight languages.

For instance, in a North American context, these eight languages may constitute: English, French, Chinese, Spanish, Arabic, Persian, Russian, and Korean. In a Western European context, it may be English, French, German, Spanish, Italian, Portuguese, and Greek and in a Middle-Eastern context, it could be: Arabic, Turkish, Persian, Kurdish, Azeri, Hebrew, English and French. These are examples of use of 3 bits for language choice and, naturally, other combinations of eight languages could be employed.

In the preferred embodiment, the SATM system of the invention includes a language choice data field language 230. The choice of the languages implemented by the language choice data field language 230 is completely reconfigurable by the operator. The number of possible languages supported depends on the number of bits allocated to that function. Thus, depending on bit selection, the number of languages can be eight, more than eight, or less than eight. Eight languages have been described here by way of example only but it is understood that the invention in limited to a particular count of languages or bit length allocated to the language 230 field.

So the user 140 selects the language (or goes with the default language). Based on this choice, necessary bits are generated in the VS 110 and transmitted to the SC 170. All the consequent messages, either voice or text, including the optional advertisement 115, will be delivered in the chosen language from both VS 110 and SC 170 sides.

Coding and Security

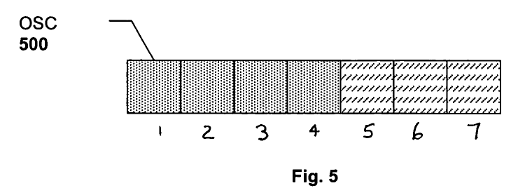

In order to ensure the integrity and security of each transaction, and the SATM system of the present invention provides encryption of the transmitted messages. Since there is no direct connectivity between the VS 110 and SC 170, user 140 or user's equipment UE 150 has to convey the messages between VS 110 and the SC 170. FIG. 5 shows a field layout of a symbol arrangement of an order synchronized code OSC 500. The use of this code will now be explained.

In the case that the user's equipment 150 is limited to voice functionality, the user 140 will punch in the data forming the TID 125 message into the UE 150. When the interaction with the SC170 completes successfully, the UE 150 will receive the authorizing CID 126 from the SC 170. The user inputs the CID 126 received by the UE 150 into VS 110 via keypad. This is a User Assisted or UADE scenario transaction. To maintain a good user experience, TID 125 is preferably limited to 7 digits and CID 126 is limited to 4 digits. Normal approaches to encryption can not be applied to this scenario because they all tend to use a large key (between 40-128 bits) which will make TID 125 and CID 126 too large for a user 140 to punch on keypad 107.

For the system of the invention to operate securely in this environment, an Order Synchronized Code (OSC 500) is used to encrypt a TID 125 message excluding the VSId 210 filed and the CID 126. The following rules govern the encryption/decryption of the messages:

In TID 125, merchant ID 210 is sent as plain text (without encryption).

In TID 125, Price and CRC/Language is encrypted.

An OSC 500 is used as the key for encryption.

SC 170 maintains a synched OSC 500 per provisioned VS 110.

For maintaining security, SC's OSC 500 peer 760 performs a look ahead for the next nLA codes to find a match.

Transaction Security by Order Synchronized Code (OSC 500)

In the preferred embodiment of a UADE scenario transaction, the invention provides a few digit OSC 500 that is generated every time a new transaction is to be fulfilled. This OSC 500 is generated independently at both in the VS 110 and at the SC 170 and they are kept synchronized on the order of the transactions, i.e., for the first transaction VS 110 and SC 170 generate the same OSC 500 and for the second and so on. The system is based on two identical pseudo random number generators with seed at the VS 110 and SC 170. In the SC 170 for each VS 110 an OSC 500 maintenance peer (OMP) 760 is created and maintained in synch upon provisioning of that VS 110. To ensure that VS 110 and SC 170 are kept in synch and don't fall out of synch, the SC 170 attempts to look ahead (or depending on the implementation, can be look behind) nLA (number of Look Ahead) codes to find a match.

FIG. 5 illustrates the OSC 500 as a few symbol long code.

The last few digits of the OSC 500 are used as a key to encrypt the Price, inventory information and Language code part of the TID 125 at the VS 110 and the same code should be used to decrypt the TID 125 at the SC 170. The first few digits of the OSC 500 are used to encrypt CID 126 at the SC 170 and again decrypt it at the VS 110. The probability of repeating a TID 125, CID 126 combination p is very small, as the encryption codes used to cipher them are independent one from the other.

A potential delinquent who wishes to use the system in a phony way, may want to enter a random number as CID 126. Below, we calculate the chance for this CID 126 to be the right one which will lead the VS 110 to release a product or to provide a service.

nSym=12 (nSym is assumed to be 12 and is the number of symbols on the keypad 107 which includes “0”-“9”, “*” and “#”; if we use only the 10 digits, then nSym would be 10).

nChar=4

p_{fraud}=1/nSym^{nChar}=1/12⁴=1/20736=0.000,048,225

with nSym equal to 10, the value becomes simply 0.0001.

To further reduce the chance of such an attempt, the system will temporarily (for instance for 30 seconds) interrupt accepting new CID 126, after a predetermined number of (for instance 3) unsuccessful attempts.

Error Detection

A Cyclic Redundancy Check (CRC) code is used as a means of error detection in both the TID 125 and the CID 126. A Frame Check Sequence (FCS) is calculated on the information bits and transmitted as redundant bits along with the information bits.

For TID 125, in the preferred realization of the system, four bits are reserved for FCS.

For CID 126, in the preferred realization of the system, four bits constitute the FCS. The whole four bytes are then encrypted.

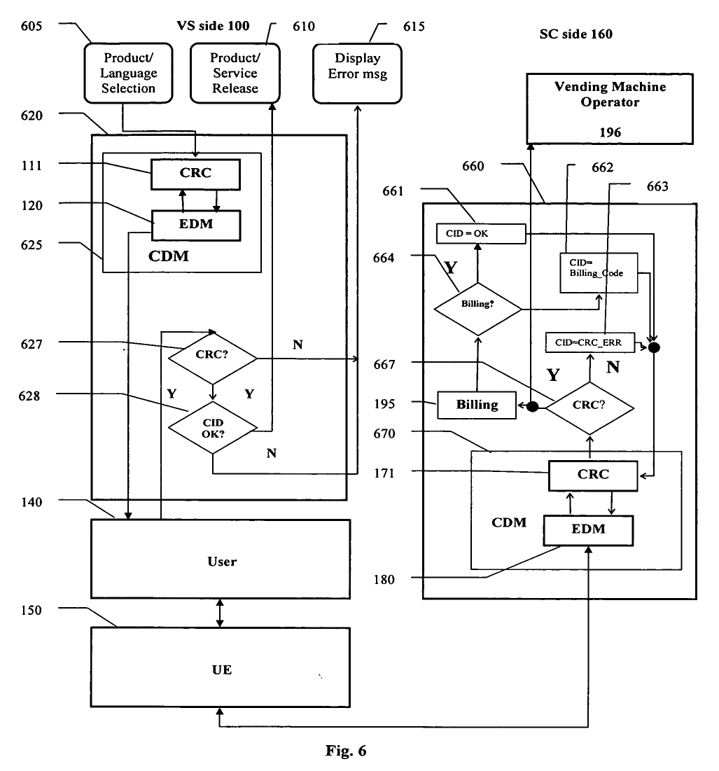

FIG. 6 shows the overall encryption and error detection mechanism in the system, by showing the flow of information. In the VS side 100, it starts in 605, where the product or service is selected (and language preference is indicated). A packet of data is then generated, CRC is then added and encryption performed in 625. Then the message is passed to the user 140. Then the message is passed to UE 150 and from there it is sent to the SC side 160. There the message is checked for CRC integrity and deciphering is made in 670. If CRC is correct, information is sent to the billing agent 195. If either the CRC is wrong or the billing agent 195 does not approve the transaction (for instance because of a bad account history), appropriate code is generated in 661 or 662.

On the way back from the SC side 160, to the VS side 100, the message is sent again to the UE 150, from there to User 140 and from there to CRC check 627, and then we check if the CID is what EDM 120 expects. If it is, then a command and a message are generated to release the product or render the service in 610. Otherwise, an error message is displayed in 615.

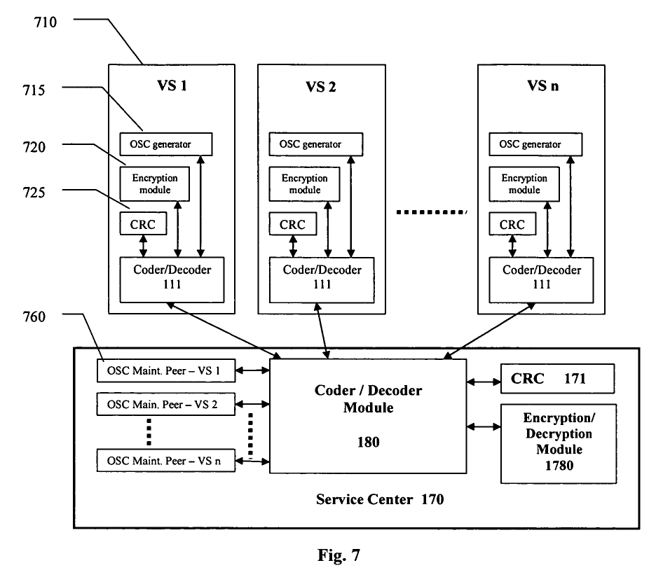

FIG. 7 shows the overall key management for the encryption mechanism in the system. The service center 170 has a bank of keys, one set for each VS 110 (showed in the figure as VS₁, VS₂, VSₙ).

User Interface

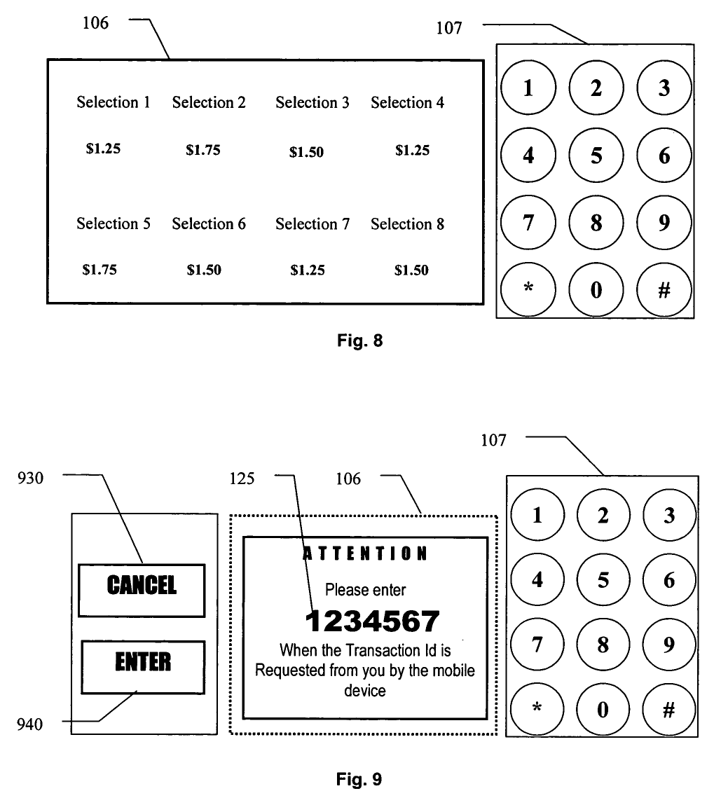

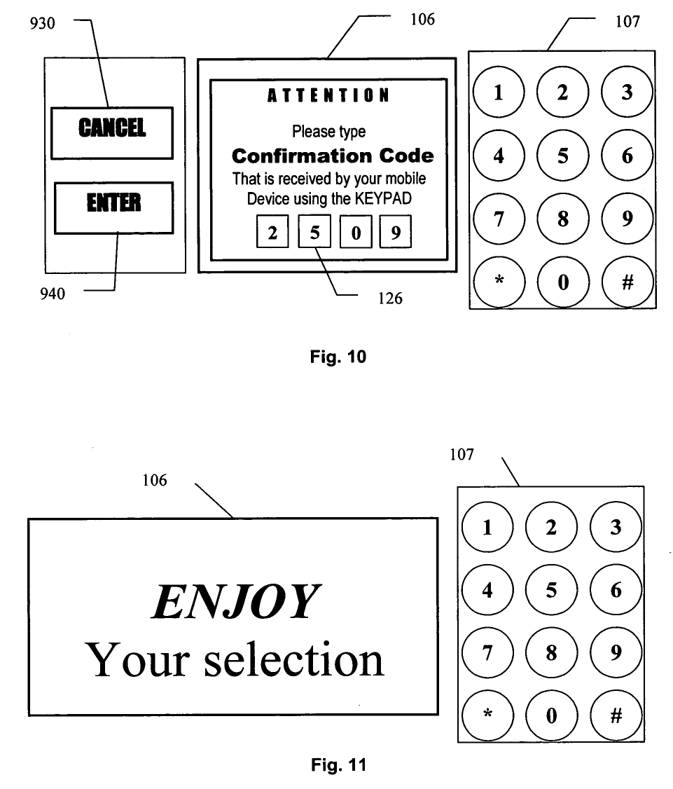

FIGS. 8, 9, 10 and 11 illustrate an exemplary arrangement of the user interface of the system for the UADE mode. Although the user interface can be built in other ways and using other shapes and form factors of keypad 107 and display 106 as well as keys and buttons 930, 940 of FIG. 10.

Billing

The Billing Proxy in the SC 170 is in direct secure contact with the billing system 1220 that is provided by the billing provider. The billing provider can be one or a combination of the following:

The Wireless Carrier

In this case the wireless carrier provides the billing service. The charges for the products/services that the subscribers purchase will be applied to the existing wireless service account that they already have established for their wireless service. If this option is opted, subscribers don't need to register and sign up for SATM service since they are already known to the billing system.

A Financial Institution

A financial institution can be designated as the billing service provider. This is probably the most extensive option for billing since the possibility of deploying the service over a broad range of products and services is much higher. An example of this scenario can be thought linking the subscribers' credit card account to their SATM service which conveniently charges all the purchases made by their mobile UE 150 to their credit card account. Another example can be a financial institution that charges user's checking account.

The Vending Station Operating Entity

The firm that is operating the chain of VS 110 can act as the billing service provider. One condition in this case is that all the wireless service users that like to use this service, need to register with the billing service provider.

The Product/Service Manufacturer/Provider

In this scenario the provider of the product or service that is being offered by SATM enabled VS 110 is providing the billing service.

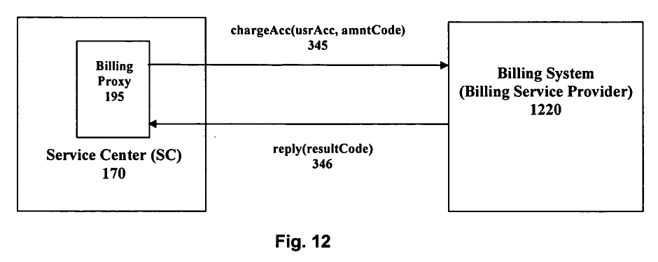

FIG. 12 is a diagram that shows how the billing service provider 1220 interacts with SC 170.

The billing service provider 1220 can reply back to a “charge account” 1230 request with one of the following reply codes 1240:

OK Charge applied

NSF Not Sufficient Fund

UU User Unknown

GF General Failure

To handle cancelling a transaction properly, the billing system keeps the billing record for a specified amount of time (billingDelay) before it applies the charge to the user's account. This delay allows the user to cancel the transaction. An example value for billingDelay can be set to 10 minutes and the billing system periodically visits the unapplied charge record and applies them if they are older than the billingDelay.

Automatic Data Exchange Mode

In this mode, the UE 150 and VS 110 have a local wireless way of communication and the need for the user to punch in the TID 125 and then the CID 126 would be eliminated. The communication between the UE 150 and VS 110 can be but not limited to any of the following: infrared (IR) 116, Bluetooth (BT) 117 or wireless LAN (such as 802.11 series) 118.

The first consequence of the automatic messaging is that the number of bytes (or digits) that are used in messaging can be more since there is less limitation by the user experience constraints and user typing errors.

In such a case, the following information can also be transmitted from VS 110 to the SC 170:

1. More bits for language selection.

2. More bits for CRC to further decrease the risk of error (or an error correcting code such as Reed-Solomon can be used instead of CRC).

3. More bits for Merchant ID or Vendor ID 210 (so the possibility to give the service to a bigger area).

4. More bits for the price (so the possibility of having more dynamic range and/or having more precision).

5. Possibility of transmitting an Initialization Vector (IV) for the encryption.

6. Possibility to transmit the inventory information (or any other information) directly from VS 110 to the SC 170.

7. Possibility to transmit the advertisement information, provisioning (or any other information) directly from SC 170 to the VS 110.

If we use the Initialization Vector, then the encryption scheme would be simplified, and the need for synchronizing the encryption systems in VS 110 and SC 170 will be eliminated. This is done by breaking the main encryption key into two parts: the constant key and Initialization Vector. The Initialization Vector is sent in plain text to the SC 170 and then the two systems use the main key. So each time a completely different key would be used and the encryption will be totally different.

In a similar manner, the CID 126 can also be expanded to include the following messages:

1. More messages from SC 170 to VS 110 (rather than limiting to a few such as “O.K.”, “NSF”, “UU” and “GF”). This would be messages such as “lock”, “give-a-reward” and other commands.

2. More bits for CRC to further decrease the risk of error (or an error correcting code such as Reed-Solomon can be used instead of CRC).

3. Advertisements or any other type of data or information, to be displayed for the used, either on his UE 150 or the VS 110.

In this configuration, the UE 150 should be equipped to run a special program when dealing with this application. SMS or other means of data connectivity between the UE 150 and the SC 170 can be used for messaging, instead of voice or in parallel to voice. UE 150 can also make use of CRC check 145 to detect some errors earlier.

List of Abbreviations

ADE Automatic Data Exchange

BT 117 Bluetooth

CDM 625, 670 Coding Decoding Module

CID 126 Confirmation ID

CRC Cyclic Redundancy Check

EDM 720,780 Encryption Decryption Module

FCS Frame Check Sequence

IR 116 Infrared

IV Initialization Vector

IVR Interactive Voice Response

OMP 760 OSC maintenance peer

OSC 500 Order Synchronized Code

PDA Personal Digital Assistant

SATM Small Amount Transaction by Mobile

SC 170 Service Center

SMS Short Message Service

TID 125 Transaction ID

UADE UserAssisted Data Exchange

UE 150 User Equipment

VS 110 Vendor System

WLAN 118 Wireless Local Area Network

What is claimed is:

1. A method for authorizing a purchase transaction, the method comprising the steps of:
i. producing a unique transaction identification code;
ii. receiving a confirmation code from the service center; and
iii. authorizing a transaction when the received confirmation code corresponds to the unique transaction identification code.

2. The method of claim 1 wherein the unique transaction identification code is produced in response to a selection request.

3. The method of claim 1 wherein the unique transaction code is encrypted by a pseudo random number generator.

4. The method of claim 3 wherein the pseudo random number generator is supplied with a selected seed number to start the sequence of pseudo random numbers.

5. A method for completion of a purchase transaction over a wireless network, the method comprising the steps of:
i. receiving a transaction identification code;
ii. establishing a connection to a service center from a mobile wireless network device over a wireless network;
iii. using the connection to provide the transaction identification code to said service center;
iv. receiving a unique confirmation code from the service center; and
v. supplying the confirmation code to a vendor as payment on a transaction.

6. The method of claim 5 further including the step of encrypting the transaction identification code after receiving it.

7. The method of claim 5 wherein the step of receiving a transaction identification code is performed in response to a selection request.

8. The method of claim 5 wherein the step of receiving a transaction identification code is performed over a wireless communication link.

9. The method of claim 8 wherein the wireless communication link is selected from one of:
i. a Bluetooth protocol link;
ii. a local area network; or
iii. an infrared link.

10. A method for validating a purchase transaction comprising the steps of:
i. receiving a transaction identification code (TID);
ii. decoding the TID;
iii. producing an order synchronized code (OSC) based on the step of decoding the TID;
iv. comparing the produced OSC to the decoded TID; and
v. producing a transaction validation on a successful comparison step.

11. The method of claim 10 further including the step of producing a confirmation identification code for a successful transaction validation.

12. The method of claim 10 further including the step of decrypting the TID.

13. The method of claim 10 further including the step of decoding the TID to produce a vendor station identification and wherein the step of producing an OSC is based on a vendor station identification.

14. The method of claims 10 wherein the OSC is produced by a pseudo random number generator.

15. The method of claim 14 wherein the pseudo random number generator is supplied with a selected seed number to start the sequence of pseudo random numbers.

16. The method of claim 10 further including the steps of:
i. decoding the TID to obtain a payment request amount;
ii. obtaining customer identification data;
iii. producing a payment authorization request from customer identification data and the payment request amount;
iv. supplying the payment authorization request to a billing proxy; and
v. receiving a payment authorization response from the billing proxy.

17. The method of claim 16 wherein the step of obtaining customer identification data is performed by obtaining the customer identification data from the caller id of the user equipment;

18. The method of claim 16 further including the step of producing a confirmation identification code (CID) on receipt of a said payment authorization response from the billing proxy.

19. The method of claim 16 further including the steps of:
i. decoding the TID to produce a vendor identification; and
ii. supplying the vendor identification to the billing proxy.

20. The method of claim 19 further including the step of producing a confirmation identification code (CID) on receipt of a said payment authorization response from the billing proxy.

21. The method of claim 10 further including the steps of:
i. decoding the TID to produce product dispenser inventory information; and
ii. supplying the inventory information to a vending operator system.
